(19) United States
(12) Patent Application Publication
(10) Pub. No.: US 2021/0387376 A1
(43) Pub. Date: Dec. 16, 2021

(54) CROSS-HATCHED BAMBOO STRAND LUMBER

(71) Applicant: Panda Industries, Inc., Jupiter, FL (US)

(72) Inventor: Austin Lee Trefes, Westerly, RI (US)

(21) Appl. No.: 17/346,229

(22) Filed: Jun. 12, 2021

Related U.S. Application Data
(60) Provisional application No. 63/039,628, filed on Jun. 16, 2020.

(51) Int. Cl. B27N 3/06; B27J 1/00; B27N 3/04

(52) U.S. Cl. CPC B27N 3/06; B27N 3/04; B27J 1/00

(57) ABSTRACT

System and method for manufacturing bamboo dimensional lumber having cross-hatched fiber layers. The method involves splitting bamboo poles into smaller slats, which are then and crushed into fibers. These fibers are covered with glue, and laid in alternating perpendicular layers. The combined layers are hot pressed to form a rough lumber board composed of cross-hatched bamboo fiber layers. The board is then cut to any desired dimensions for lumber.

### CROSS REFERENCE TO RELATED APPLICATION

This application claims the benefit of U.S. Provisional Patent Application No. 63/039,628 filed on Jun. 16, 2020, the contents of which are incorporated herein by reference.

### FIELD OF THE INVENTION

The present invention relates to a method of producing bamboo dimensional lumber having cross-hatched fiber layers.

### BACKGROUND OF INVENTION

Worldwide climate change is being accelerated through the extraction, processing, burning, and release of stored carbon deposits from the ground into the atmosphere. This stored carbon has accumulated into ground deposits over millions of years. The burning and release of this carbon into our oceans and atmosphere is at a much faster rate than can be reabsorbed into the ground, resulting in the greenhouse effect of heating the atmosphere and acidifying the oceans. This has the potential to destroy ecosystems at the microscopic level, and leading to collapses higher up the food chain.

There are two ways to address and attempt to fix this issue: by releasing less carbon into the oceans and atmosphere and absorbing the released carbon already emitted at higher rates.

The first solution involves replacing fossil fuels as sources of energy with more renewable sources, such as solar and wind power.

The second solution, absorbing released carbon at a higher rate, is generally achieved by planting carbon absorbing trees. In addition, carbon absorbing products and machines are also being developed that perform the same duty as trees. While carbon absorbing machines are efficient, they require a lot of energy to develop and operate, including running factories to build them, distribution, maintenance, and advanced engineering.

A more natural, and low energy cost solution may be found in bamboo. Bamboo absorbs 340% more carbon dioxide from the atmosphere as the average hardwood tree, can grow in 4-10 years compared to other hardwood trees which may take 25-50 years. Bamboo, as a grass, can also be harvested for lumber without killing the plant, resulting in faster regrowth over replanting hardwood trees that must be killed to harvest lumber.

Bamboo produces a comparatively strong hardwood lumber. The strongest wood in any given species is that without knots, called clear wood, and all bamboo is essentially clear wood. Bamboo can therefore be used in manufacturing with less waste. Bamboo is uniform in strength, and therefore, viable as a structural member. This lumber strength combined with its extremely efficient growth rate gives bamboo the potential to replace hardwoods as a common building material. If commonly used construction hardwood trees were replaced with bamboo, an equal amount of planted bamboo would absorb 340% more carbon dioxide from the atmosphere.

Despite these advantages, bamboo does have a number of disadvantages in overcoming hardwood tree usage as a source of lumber. These disadvantages include: a lack of a domestic bamboo supply in most developed countries, the hardness of bamboo preventing nailing, and the unwillingness of builders to switch commonly used hardwood tree lumber materials. Even in countries where bamboo is prevalent, bamboo requires more manufacturing to produce lumber over a hardwood tree due to bamboo's round and hollow internodes, which have a tendency of splitting and breaking. Modern construction techniques need standardization that only dimensional lumber can provide. Therefore, there remains a need for a process and method of creating usable bamboo lumber with structural integrity.

The following invention describes a type of bamboo lumber that can be created from cross-hatching bamboo fibers and hot pressing them into lumber boards with adhesives, and cutting them into a smaller dimensional lumber studs. The cross-hatched bamboo lumber of this invention will lock any construction nail into place and will prevent bamboo fibers from exploding.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a method producing dimensional lumber from raw bamboo, the method comprising: a) cutting a plurality of bamboo poles from raw bamboo; b) stripping all leaves and branches form the plurality of bamboo poles; c) submerging the plurality of bamboo poles in fire retardant, insecticide, and a fungicide; d) splitting the plurality of bamboo poles into a plurality of slats; e) planing the top and bottom surfaces of each of the plurality of slats; f) crushing the plurality of slats into bamboo fibers; g) submerging the bamboo fibers in glue; h) laying a first portion of the bamboo fibers in a first orientation to form a first layer; i) laying a second portion of the bamboo fibers in a second orientation to form a second layer on top of the first layer, wherein the second orientation is substantially perpendicular with the first orientation; j) repeating steps h) and i) to form a plurality of layers that are substantially perpendicular with each other; k) hot-pressing the plurality of layers into a bamboo board; and m) cutting the bamboo board into dimensional lumber.

The subject invention discloses a method for producing dimensional lumber from raw bamboo, the method comprising: a) cutting a plurality of bamboo poles from raw bamboo; b) splitting the plurality of bamboo poles into a plurality of slats; c) planing the top and bottom surfaces of each of the plurality of slats; d) crushing the plurality of slats into bamboo fibers; e) submerging the bamboo fibers in glue; f) laying a first portion of the bamboo fibers in a first orientation to form a first layer; g) laying a second portion of the bamboo fibers in a second orientation to form a second layer on top of the first layer, wherein the second orientation is substantially perpendicular with the first orientation; h) repeating steps f) and g) to form a plurality of layers that are substantially perpendicular with each other; i) hot-pressing the plurality of layers into a bamboo board; and j) cutting the bamboo board into dimensional lumber.

The subject invention discloses a method producing lumber from raw bamboo, the method comprising: a) cutting a plurality of bamboo culms from raw bamboo; b) stripping all leaves and branches form the plurality of bamboo culms; c) submerging the plurality of bamboo culms in fire retardant, insecticide, and a fungicide; d) splitting the plurality of bamboo culms into a plurality of slats; e) planing the top and bottom surfaces of each of the plurality of slats; f) crushing the plurality of slats into bamboo fibers; g) submerging the bamboo fibers in glue; h) laying a first portion of the bamboo fibers in a first orientation to form a first layer; i) laying a second portion of the bamboo fibers in a second orientation to form a second layer on top of the first layer, wherein the second orientation is substantially perpendicular with the first orientation; j) repeating steps h) and i) to form a plurality of layers that are substantially perpendicular with each other; k) hot-pressing the plurality of layers into a bamboo board; and m) cutting the bamboo board into dimensional lumber.

The subject invention discloses a method producing lumber from raw bamboo culms, the method comprising: a) stripping all leaves and branches form the plurality of bamboo culms; b) submerging the plurality of bamboo culms in fire retardant, insecticide, and a fungicide; c) splitting the plurality of bamboo culms into a plurality of slats; d) planing the top and bottom surfaces of each of the plurality of slats; e) crushing the plurality of slats into bamboo fibers; f) submerging the bamboo fibers in glue; g) laying a first portion of the bamboo fibers in a first orientation to form a first layer; h) laying a second portion of the bamboo fibers in a second orientation to form a second layer on top of the first layer, wherein the second orientation is substantially perpendicular with the first orientation; i) repeating steps g) and h) to form a plurality of layers that are substantially perpendicular with each other; j) hot-pressing the plurality of layers into a bamboo board; and k) cutting the bamboo board into dimensional lumber.

The subject invention discloses a method producing lumber from raw bamboo culms, the method comprising: a) splitting the plurality of bamboo culms into a plurality of slats; b) planing the top and bottom surfaces of each of the plurality of slats; c) crushing the plurality of slats into bamboo fibers; d) submerging the bamboo fibers in glue; e) laying a first portion of the bamboo fibers in a first orientation to form a first layer; f) laying a second portion of the bamboo fibers in a second orientation to form a second layer on top of the first layer, wherein the second orientation is substantially perpendicular with the first orientation; g) repeating steps e) and f) to form a plurality of layers that are substantially perpendicular with each other; h) pressing the plurality of layers into a bamboo board; and i) cutting the bamboo board into dimensional lumber.

A dimensional piece of bamboo lumber, comprising: a plurality of layers hot-pressed in orientations substantially perpendicular with each other, wherein each layer comprises a portion of bamboo fibers submerged in glue and laid in a substantially aligned orientation, wherein each bamboo fiber comprises a plurality of crushed bamboo slats with planed top and bottom surfaces, wherein each bamboo slat comprises split and stripped raw bamboo poles submerged in fire retardant, insecticide, and a fungicide.

A piece of raw bamboo lumber cut into desired dimensions, the lumber comprising: a plurality of bamboo layers hot-pressed in orientations substantially perpendicular with each other, wherein each layer comprises a portion of raw bamboo fibers submerged in glue and laid in a substantially aligned orientation, wherein each raw bamboo fiber comprises a plurality of raw crushed bamboo slats with planed top and bottom surfaces, wherein each raw bamboo slat comprises split raw bamboo poles stripped of leaves and branches and submerged in fire retardant, insecticide, and a fungicide.

A piece of bamboo lumber, the lumber comprising: a plurality of bamboo layers pressed in orientations substantially perpendicular with each other, wherein each layer comprises bamboo fibers submerged in glue and placed in a substantially aligned and flat orientation, wherein each bamboo fiber comprises a plurality of bamboo slats planed on the top and bottom surfaces and then crushed, wherein each bamboo slat comprises raw bamboo poles stripped of leaves and branches, split, and submerged in fire retardant, insecticide, and a fungicide.

A piece of bamboo lumber, the lumber comprising: a plurality of bamboo layers pressed in orientations substantially perpendicular with each other, wherein each layer comprises bamboo fibers submerged in glue and placed in a substantially aligned and flat orientation, wherein each bamboo fiber comprises a plurality of bamboo slats planed on the top and bottom surfaces and then crushed, wherein each bamboo slat comprises raw bamboo culms stripped of leaves and branches and split.

In embodiments of the subject invention, the raw bamboo may be four to ten years of age from germination.

In embodiments of the subject invention, the bamboo poles may be two to six meters long and 120 to 140 millimeters in diameter.

In embodiments of the subject invention, the raw bamboo may be selected from a species comprising the group consisting of: Guadua angustofolia, Phyllostachys edulis, Dendrocalamus giganteus, and Bambusa oldhamii.

In embodiments of the subject invention, the raw bamboo may comprise 10-20% moisture content.

In embodiments of the subject invention, the slats may be substantially trapezoidal shaped prisms.

In embodiments of the subject invention, the top surface of each slat may comprise a cutin layer and the bottom surface of each slate may comprise a sclerenchyma layer, which are each planed off before proceeding to the next step.

In embodiments of the subject invention, the bamboo fibers may be two to four millimeters in diameter and two to six meters long.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

In embodiments of the subject invention, the term “relatively” is defined as a comparison of a property, or the proportion of a property between two components.

### BRIEF DESCRIPTION OF THE DRAWINGS

Advantages of the present invention will be apparent from the following detailed description of embodiments, which description should be considered in conjunction with the accompanying drawings, in which:

FIG. 1 is a flowchart showing the steps of creating bamboo dimensional lumber.

FIG. 2 illustrates an isometric view of a bamboo pole.

FIG. 3 illustrates an isometric view of a bamboo pole that is split into slats with a splitter tool.

FIG. 4 illustrates an isometric view of a bamboo pole slats that were split with a splitter tool.

FIG. 5 illustrates an isometric view of a bamboo pole splitter tool.

FIG. 6 illustrates an isometric view of bamboo slats being processed through a fluffer machine.

FIG. 7 illustrates an isometric view of bamboo crushed fiber layers glued with opposing fiber orientations.

FIG. 8 illustrates an isometric view of a hot pressed bamboo board and a cutout stud.

### DETAILED DESCRIPTION OF THE EMBODIMENTS

While several variations of the present invention have been illustrated by way of example in particular embodiments, it is apparent that further embodiments could be developed within the spirit and scope of the present invention. However, it is to be expressly understood that such modifications and adaptations are within the spirit and scope of the present invention, and are inclusive, but not limited to the following appended claims as set forth.

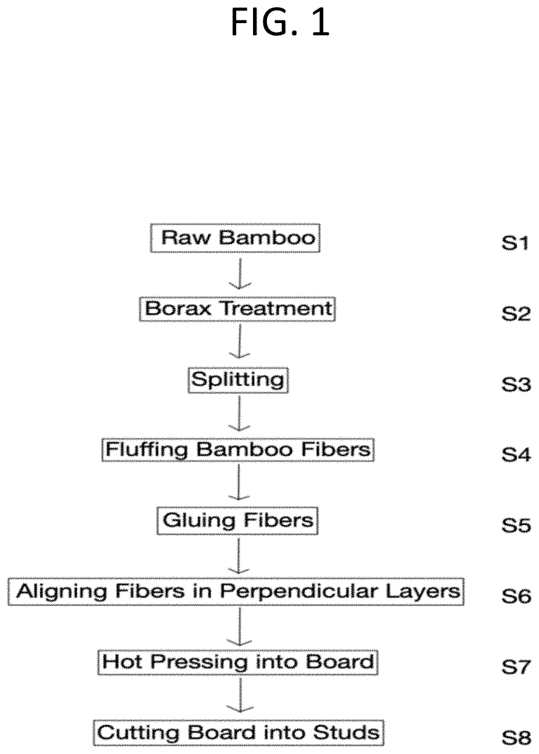

FIG. 1 is a flowchart depicting the method and process for creating bamboo dimensional lumber in accordance with an embodiment of the present invention.

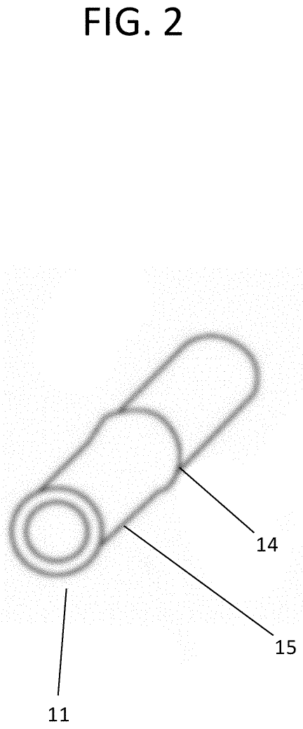

In the first step S1 of the invention, raw bamboo jointed stems or culms, grown for four to ten years in a forest or farm, are cut into poles 11 several meters long. Bamboo older than ten years is likely unsuitable as it begins to decrease in strength, and bamboo younger than four years has not reached sufficient size or strength. These bamboo poles 11 are stripped of all leaves and branches, as illustrated in FIG. 2. The bamboo poles 11 will be two to six meters long and roughly 120 to 140 millimeters in diameter.

As illustrated in FIG. 2, bamboo jointed stems or culms are composed of hollow nodes 15 and solid internodes 14 that repeat, in sequence, throughout the length of the culm. While bamboo is a grass and does not have knots like standard hardwoods, it does have nodes that are denser than the fibers of the internodes. If a bamboo dimensional lumber is made improperly, these varying densities can alter the strength of the final lumber product. The strongest hardwood in any given species is that without knots, called “clear wood”. Despite the differing densities between nodes and internodes, bamboo is a clear wood, so much less of it is wasted, it is more uniform in strength, and more viable as a structural component.

In embodiments of the subject invention, the following species of bamboo are the most preferred: Guadua angustofolia, Phyllostachys edulis, Dendrocalamus giganteus, and Bambusa oldhamii. These bamboo species are known to grow culms over twenty meters high and have “structural” grade strengths. Before proceeding, the bamboo will preferably have a 10-20% moisture content.

In the second step S2 of the invention, the cut bamboo poles 11 are submerged in a boron/borax solution to make them more resistant against fire, insect, and fungal damage. In embodiments of the subject invention, the bamboo pole 11 is submerged in the solution for less than a day at about room temperature.

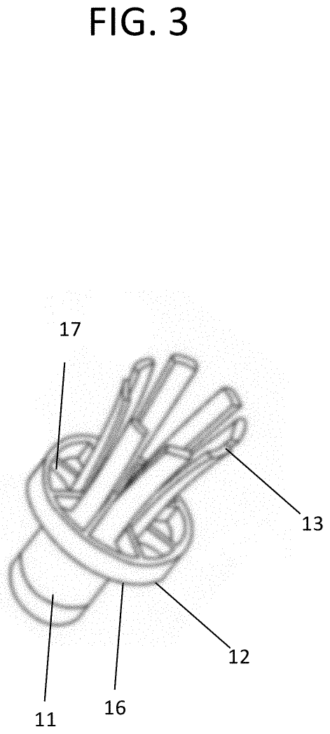

In the third step S3 of the invention, the bamboo pole 11 is split by using a splitter tool 12 transforming the pole 11 into slats 13, as illustrated in FIG. 3. The bamboo pole 11 must be broken down into a denser medium before it can be processed into dimensional lumber. The hollow bamboo poles 11 must be cut into smaller slats 13, to remove the hollowness, and then built back up as a dense lumber beam or stud.

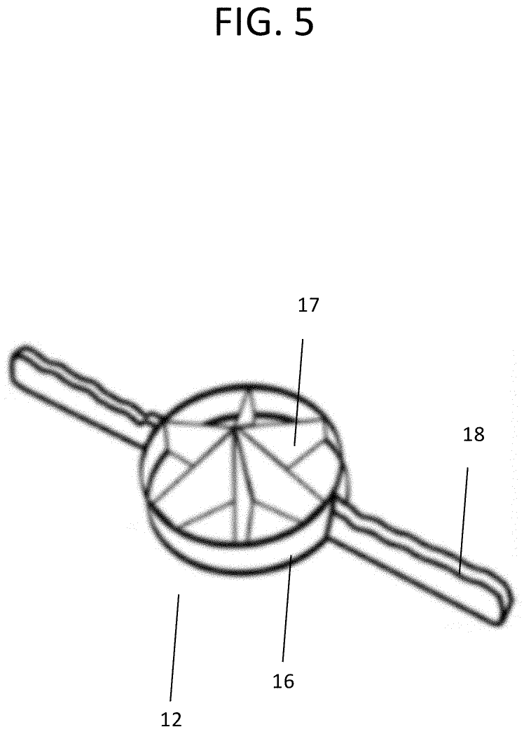

As illustrated in FIG. 5, the splitting tool 12 is a steel tool that is made up of a circular frame 16, intersected usually by four to ten sharp pieces of steel 17. Bamboo poles 11 are forced through frame 16 and steel pieces 17, leaving a multitude of slats 13. The splitting tool 12, may have handles 18, to allow a worker to manually force the bamboo pole 11 into slats 13. In some embodiments, the splitting tool 12 breaks bamboo pole 11 into eight slats 13. However, any number of slats can be created using the splitting tool 12. In further embodiments of the subject invention, the splitting process can be mechanized and automated.

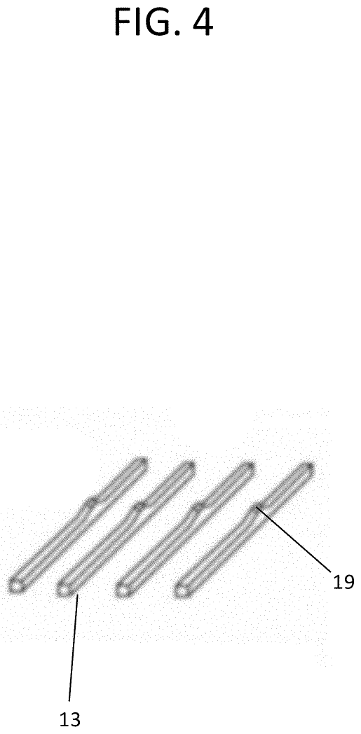

As illustrated in FIG. 4, the bamboo slats 13, produced by splitting the poles 11, are reasonably trapezoidal shaped prisms of bamboo. The slats 13 are as long as the original culm of bamboo pole 11. The solid internode 14 of the bamboo that occurs periodically between the hollow nodes 15 is now visible as a notch 19 in the slats 13.

Before proceeding to the next step, the notches 19, the top layer, and the bottom layer must be removed from each slat 13.

The top and bottom of each slat 13, that is, the inside and outside layers of the original hollow bamboo pole 11, before splitting it in the previous step, need to be planed.

A bamboo pole's 11 outermost layer (the bottom layer of each slat 13), is the bark. The bark consists of epidermal cells that contain a waxy layer called cutin. A bamboo pole's 11 innermost layer (the top layer of each slat 13) consists of sclerenchyma cells. The main tissue of bamboo pole 11 contains parenchyma cells and vascular bundles. Vascular bundles are a combination of vessels and sieve tubes, with companion cells and fibers. The cutin and sclerenchyma layers are undesirable (the bottom and top layers of each slat 13), along with the notches 19, and need to be planed off. At most, this means shaving off three millimeters from the top and bottom of each slat 13, leaving the parenchyma cells and vascular bundles, which are the strongest and most workable fibers in the culm.

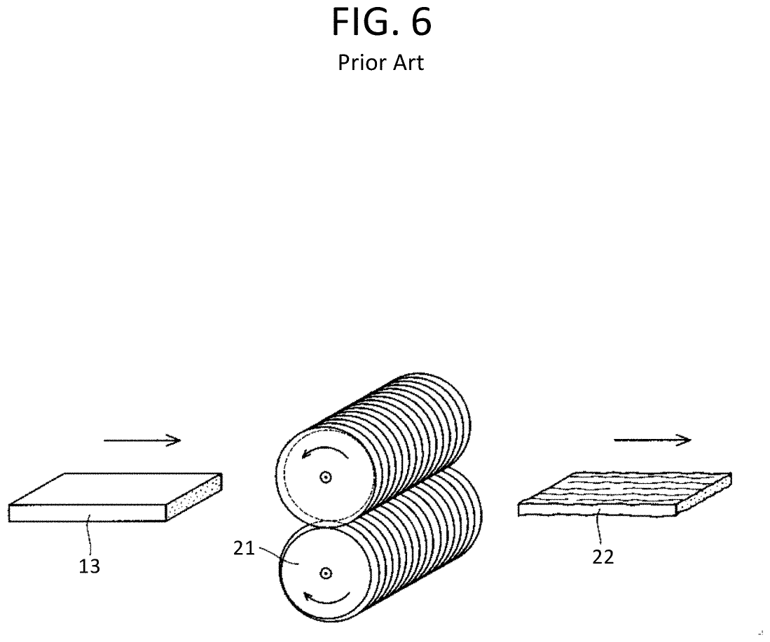

In the fourth step S4 of the invention, the planed slats 13 are broken down into fibers. This portion of the process is also known as crushing or fluffing the fibers. As illustrated in FIG. 6, this step can be accomplished by using a machine with opposing steel rollers 21 that have jagged edges flush with one another. These rollers 21 rotate around rotation shafts in opposing directions. Bamboo slats 13 are fed through the rotating steel rollers 21 and crushed to produce fibers 22. The rotating steel rollers 21 apply a compressive force on the slats' 13 longitudinal axis, which breaks the bonds holding the slats 13 together, leaving fibers 22 roughly 3 mm in diameter. In embodiments of the subject invention, the step of breaking slats 13 into fibers 22 can be done in a number of ways, but the preferred outcome is bamboo fibers 22 that are two to four millimeters in diameter that run the full length of the original bamboo pole 11 of several meters.

In the fifth step S5 of the invention, the crushed bamboo fibers 22 are submerged in an adhesive or glue solution. In some embodiments of the subject invention, all sides of every fiber are lathered in adhesive. In further embodiments of the subject invention, the adhesives may be soy-based adhesives, melamine, or formaldehyde. In additional embodiments of the subject invention, the glue or adhesive may also contain Sodium Borate or Zinc Borate to act as a pesticide, fungicide, and fire retardant to the bamboo. This gluing process can be done by hand, or by a mechanized process.

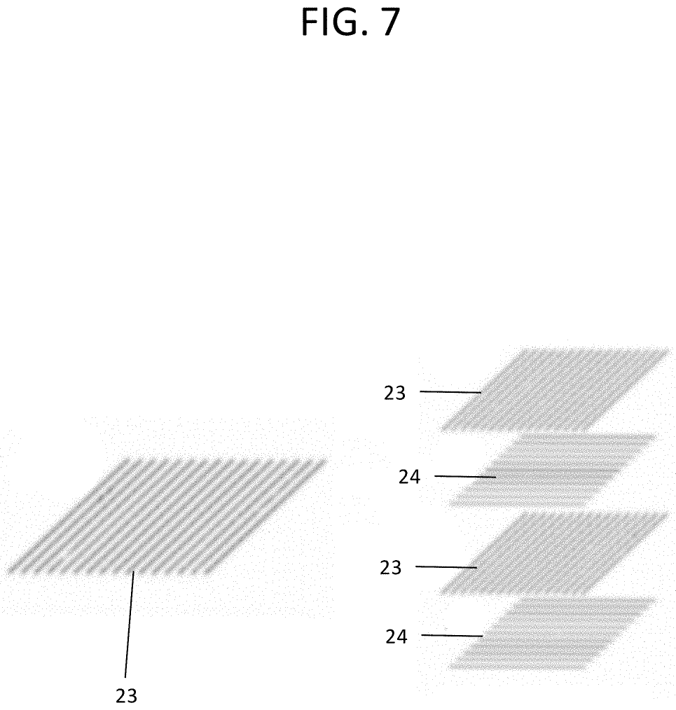

In the sixth step S6 of the invention, as illustrated in FIG. 7, the bamboo fibers 22, covered with glue, are laid with the same orientation to produce a first layer 23 with a first orientation. In embodiments of the subject invention, the first layer 23 is substantially square in shape with glued fibers 22 laid in an approximately square grid with sides equal to the length of the fibers 22. The first layer 23 may contain any number of slats 13 worth of fibers 22, such as one, two, three, four, five, or more than five slats 13 worth of fibers 22.

Bamboo fibers 22, covered with glue, are then laid in a second orientation to produce a second layer 24 on top of the first layer 23. In embodiments of the subject invention, the second layer 24 is substantially square in shape with glued fibers 22 laid in an approximately square grid with sides equal to the length of the fibers 22. The second layer 24 may contain any number of slats 13 worth of fibers 22, such as one, two, three, four, five, or more than five slats 13 worth of fibers 22.

The second orientation of the second layer 24 is substantially perpendicular with the first orientation of the first layer 23. Additional layers of bamboo fiber 22, are laid in the same orientation to produce layers that are substantially perpendicular with each layer below, to produce a cross-hatched grid.

FIG. 7 illustrates an exploded view of layers 23 and 24 glued in a cross-hatched pattern. In one example, if each bamboo fiber 22 is three millimeters in diameter and each pole 11 was originally two meters long, then one layer 23 or 24 would be three millimeters high (or thick) and two by two meters in length and width. In this example, in order to make a board two inches high, roughly seventeen layers would need to be laid perpendicular to one another to make a board 50.8 millimeters thick by two meters in length by two meters in width.

In the seventh step S7 of the invention, the cross-hatched fiber layers 23 and 24, and so forth, are hot-pressed after transferring the fiber layers onto a hot press platform. In embodiments of the subject invention, any variants of hot presses known in the art may be used if it accomplishes the goal of applying heat and pressure to cure whatever adhesive is being used to bind the bamboo fiber layers 23 and 24. For example, a soy-based adhesive provided by the company Soyad, for example, requires 1.034 MPa of pressure at a temperature around 121 degrees Celsius. These specifications can be altered for various glue types.

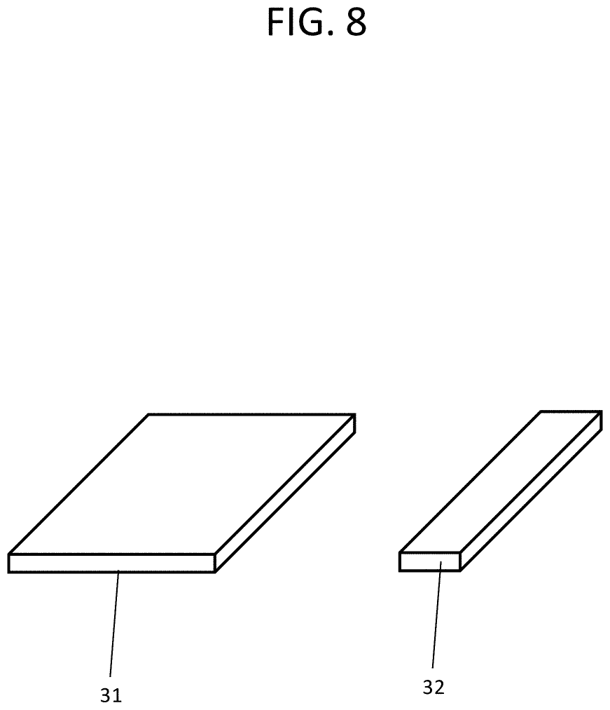

After hot pressing, the result is a board 31, illustrated in FIG. 8.

In the eighth step S8 of the invention, the board 31 is cut into one or more studs 32 of any desired shape and size and is ready for use as construction lumber. Following the previous example, if a board 31 that is 50.8 millimeters thick by two-meter length by two-meter board is created, this can be cut into twelve studs that are two inches' height by six inches width and six feet long. Any shape could be cut from board 31.

The devices, systems, and methods disclosed herein are not to be limited in scope to the specific embodiments described herein. Indeed, various modifications of the devices, systems, and methods in addition to those described will become apparent to those of skill in the art from the foregoing description.

1. A method producing dimensional lumber from raw bamboo, the method comprising:
a) cutting a plurality of bamboo poles from raw bamboo;
b) stripping all leaves and branches form the plurality of bamboo poles;
c) submerging the plurality of bamboo poles in fire retardant, insecticide, and a fungicide;
d) splitting the plurality of bamboo poles into a plurality of slats;
e) planing the top and bottom surfaces of each of the plurality of slats;
f) crushing the plurality of slats into bamboo fibers;
g) submerging the bamboo fibers in glue;
h) laying a first portion of the bamboo fibers in a first orientation to form a first layer;
i) laying a second portion of the bamboo fibers in a second orientation to form a second layer on top of the first layer, wherein the second orientation is substantially perpendicular with the first orientation;
j) repeating steps h) and i) to form a plurality of layers that are substantially perpendicular with each other;
k) hot-pressing the plurality of layers into a bamboo board; and
m) cutting the bamboo board into dimensional lumber.

2. The method of claim 1, wherein the raw bamboo is four to ten years of age from germination.

3. The method of claim 1, wherein the bamboo poles are two to six meters long and 120 to 140 millimeters in diameter.

4. The method of claim 1, wherein the raw bamboo is selected from a species comprising the group consisting of: Guadua angustofolia, Phyllostachys edulis, Dendrocalamus giganteus, and Bambusa oldhamii.

5. The method of claim 1, wherein the raw bamboo comprises a 10-20% moisture content.

6. The method of claim 1, wherein the slats are substantially trapezoidal shaped prisms.

7. The method of claim 1, wherein the top surface of each slat substantially comprises a cutin layer and the bottom surface of each slate substantially comprises a sclerenchyma layer, which are each planed off before proceeding to step f).

8. The method of claim 1, wherein the bamboo fibers are two to four millimeters in diameter and two to six meters long.

8. A method for producing dimensional lumber from raw bamboo, the method comprising:
a) cutting a plurality of bamboo poles from raw bamboo;
b) splitting the plurality of bamboo poles into a plurality of slats;
c) planing the top and bottom surfaces of each of the plurality of slats;
d) crushing the plurality of slats into bamboo fibers;
e) submerging the bamboo fibers in glue;
f) laying a first portion of the bamboo fibers in a first orientation to form a first layer;
g) laying a second portion of the bamboo fibers in a second orientation to form a second layer on top of the first layer, wherein the second orientation is substantially perpendicular with the first orientation;
h) repeating steps f) and g) to form a plurality of layers that are substantially perpendicular with each other;
i) hot-pressing the plurality of layers into a bamboo board; and
j) cutting the bamboo board into dimensional lumber.

9. The method of claim 8, wherein the raw bamboo is four to ten years of age from germination.

10. The method of claim 8, wherein the bamboo poles are two to six meters long and 120 to 140 millimeters in diameter.

11. The method of claim 8, wherein the raw bamboo is selected from a species comprising the group consisting of: Guadua angustofolia, Phyllostachys edulis, Dendrocalamus giganteus, and Bambusa oldhamii.

12. The method of claim 8, wherein the raw bamboo comprises a 10-20% moisture content.

13. The method of claim 8, wherein the slats are substantially trapezoidal shaped prisms.

14. The method of claim 8, wherein the top surface of each slat substantially comprises a cutin layer and the bottom surface of each slate substantially comprises a sclerenchyma layer, which are each planed off before proceeding to step c).

15. The method of claim 8, wherein the bamboo fibers are two to four millimeters in diameter and two to six meters long.
